(19) United States
(12) Patent Application Publication
(10) Pub. No.: US 2016/0240329 A1
(43) Pub. Date: Aug. 18, 2016

(54) CIRCUIT BREAKER INCLUDING CURRENT PATH GEOMETRIES THAT INCREASE CONTACT POPPING LEVEL

(71) Applicant: General Electric Company, Schenectady, NY (US)

(72) Inventors: Hardik Upadhyay, Meriden, CT (US); Shawn Couceiro Fonseca, Newington, CT (US); Linda Yvonne Jacobs, Barkhamsted, CT (US); Dhirendra Kumar Tiwari, Farmington, CT (US)

(21) Appl. No.: 14/624,471

(22) Filed: Feb. 17, 2015

(51) Int. Cl. H01H 1/22; H01H 1/023

(52) U.S. Cl. CPC H01H 1/22; H01H 1/023; H01H 2203/036

(57) ABSTRACT

A circuit breaker includes a housing, and a movable contact arm arranged in the housing. The movable contact arm includes a movable contact. A stationary contact assembly is arranged in the housing. The stationary contact assembly includes a base member including a first side and an opposing, second side. An anti-popping recess having a wall portion formed in one of the first and second sides and defines a cantilevered arm portion. A stationary contact member extends from the first side toward the second side.

### BACKGROUND OF THE INVENTION

The subject matter disclosed herein relates to the art of circuit breakers and, more particularly, to a circuit breaker including current path geometries that increase contact popping levels.

A circuit breaker includes one or more stationary contacts and one or more movable contacts that are connected to close a circuit to pass electrical current. In the event that the electrical current exceeds predetermined parameters, such as during a short circuit event, the movable contact(s) is/are shifted away from the stationary contact(s) to open the circuit. In some cases, the movable contact may chatter or pop at certain current levels. Popping generally results from forces that are generated in a direction of contact opening due to magnetic constriction forces. Popping may create arcing events that reduce an overall service life of the contacts and the circuit breaker.

### BRIEF DESCRIPTION OF THE INVENTION

According to one aspect of an exemplary embodiment, a circuit breaker includes a housing, and a movable contact arm arranged in the housing. The movable contact arm includes a movable contact. A stationary contact assembly is arranged in the housing. The stationary contact assembly includes a base member including a first side and an opposing second side. An anti-popping recess having a wall portion is formed in one of the first and second sides and defines a cantilevered arm portion. A stationary contact member extends from the first side toward the second side.

According to another aspect of an exemplary embodiment, a circuit breaker includes a housing, and a first contact assembly arranged in the housing. The first contact assembly includes a first contact member. A second contact assembly is arranged in the housing. The second contact assembly includes a contact portion having a first side and an opposing, second side. An anti-popping recess having a wall portion is formed in one of the first and second sides and defines a cantilevered arm portion. The first contact assembly being attracted to the second contact assembly upon an application of electrical current through the circuit breaker.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a circuit breaker including contacts having a current path geometry that increases a contact popping level shown in an open configuration, in accordance with an exemplary embodiment;

FIG. 2 depicts the circuit breaker of FIG. 1 with the contacts having a current path geometry that increases a contact popping level shown in a closed configuration;

FIG. 3 depicts a circuit breaker contact having a current path geometry that increases a contact popping level, in accordance with aspect of an exemplary embodiment;

FIG. 4 depicts current flow vectors passing through the circuit breaker contact of FIG. 2; and

FIG. 5 depicts current flow vectors passing through a prior art circuit breaker contact.

The detailed description explains embodiments of the invention, together with advantages and features, by way of example with reference to the drawings.

### DETAILED DESCRIPTION OF THE INVENTION

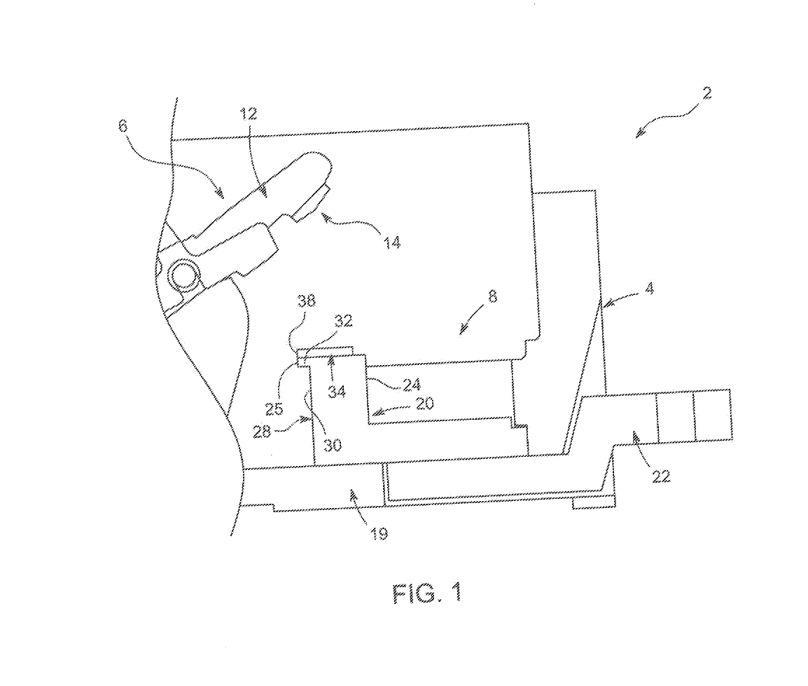

A circuit breaker, in accordance with an exemplary embodiment, is indicated generally at 2, in FIG. 1. Circuit breaker 2 includes a housing 4 that encloses a first or movable contact assembly) 6 and a second or stationary contact assembly 8. Movable contact assembly 6 includes a movable contact arm 12 that supports a movable contact 14 which, in accordance with an aspect of an exemplary embodiment, may be formed from silver, a silver alloy, or other electrically conductive materials.

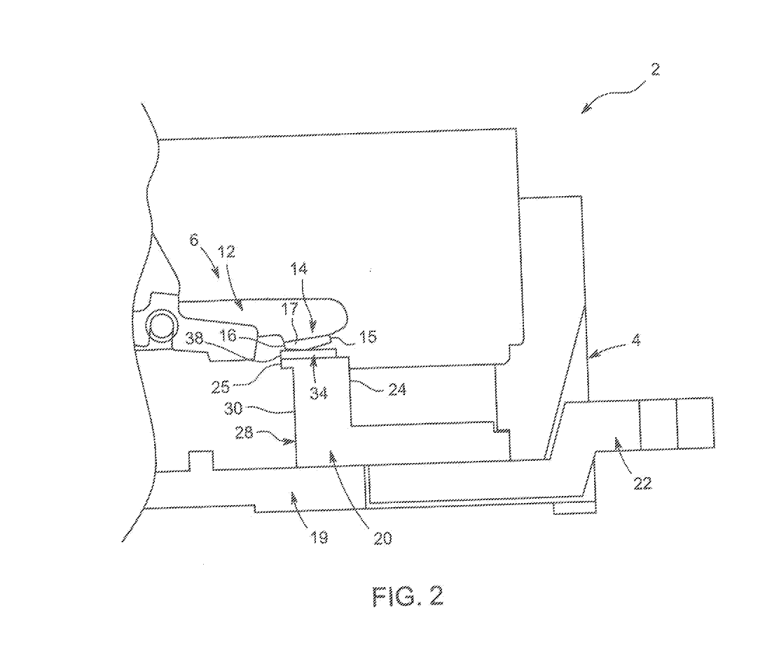

In accordance with an exemplary embodiment, stationary contact assembly 8 includes a contact portion 19 having a base member 20 that is electrically coupled to a lug or connection strap 22. Connection strap 22 may provide a connection point for an electrical load (not shown). Connection strap 22 may also provide a connection point for a source of electricity or line connection (also not shown). Base member 20 includes a first side 24 and an opposing, second side 25. Base member 20 may also include a third side (not separately labeled) and an opposing fourth side (also not separately labeled). Second side 25 includes an anti-popping recess 28 having a wall portion 30 that is off-set relative to first and second sides 24 and 25. Anti-popping recess 28 establishes a cantilevered arm portion 32 on contact portion 19. Wall portion 30, in accordance with the exemplary embodiment shown, extends substantially parallel to first and second sides 24 and 25 and substantially aligns with second end portion 16 of movable contact 14 when circuit breaker 2 is in a closed or electrically conducting configuration such as shown in FIG. 2.

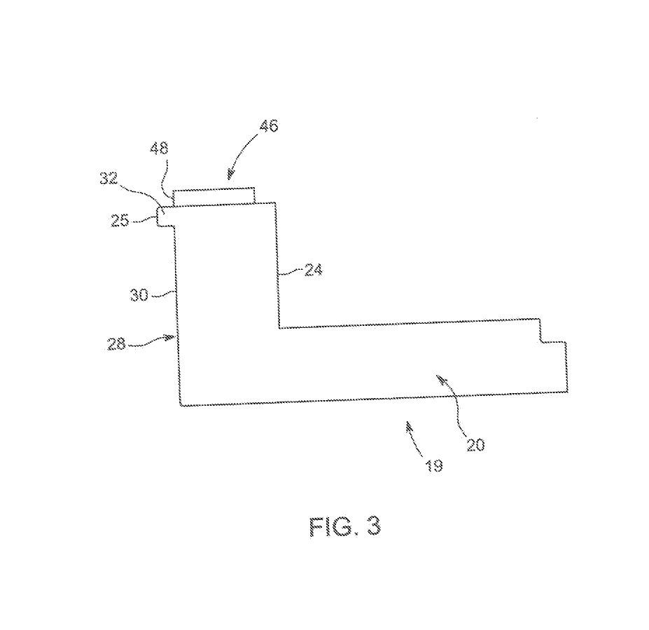

Anti-popping recess 28 promotes magnetic flux lines that establish an attractive force which draws movable contact 14 toward contact portion 19. In addition, contact portion 19 may also include a stationary contact member 34 coupled to base member 20. Stationary contact member 34 may be formed from silver, a silver alloy, or other electrically conductive materials and includes an end portion 38 that may be co-extensive or substantially align with second side 25 of base member 20. Stationary contact member 34 promotes forward loop attraction forces that reduce repulsion forces and further draw movable contact 14 toward stationary contact member 34. In accordance with another aspect of an exemplary embodiment illustrated in FIG. 3, a stationary contact member 46 may include an end portion 48 that may be co-extensive or substantially align with wall portion 30.

In accordance with an aspect of an exemplary embodiment, anti-popping recess 28 includes a desired depth and a desired height. The desired depth is represented by a distance between second side 25 and wall portion 30. The desired height, e.g., a length of wall portion 30, establishes a desired thickness of cantilevered arm portion 32. The desired thickness of cantilevered arm portion 32, in accordance with an exemplary aspect, should be understood to include a thickness of stationary contact member 34. In this manner, anti-popping recess 28 and cantilevered arm portion 32 influence magnetic flux through movable contact 14 and stationary contact member 34. In accordance with an aspect of an exemplary embodiment, a desired ratio of a depth of anti-popping recess 28 verses a thickness of cantilevered arm portion 32 is about 2:7. In accordance with another aspect of an exemplary embodiment, the desired ratio is about 4:6. In accordance with yet another aspect of an exemplary embodiment, the desired ratio is about 3:5. Of course, it should be understood that the desired ratio may vary depending upon contact geometries, current, and material properties of movable contact assembly 6 and stationary contact assembly 8. Further, it should be understood that the desired height will also affect the desired thickness of cantilevered arm portion 32 and stationary contact member 34 and thus play a role in establishing the desired ratio.

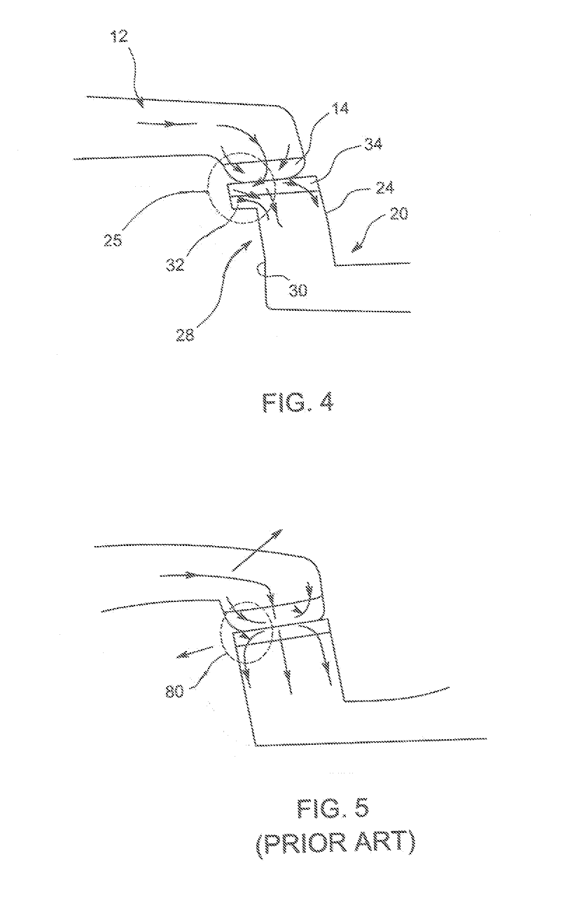

In further accordance with an exemplary embodiment, anti-popping recess 28 establishes desired current flow vectors through stationary contact member 34 and movable contact 14. More specifically, current flow vectors flux lines that pass through stationary contact member 34 are substantially parallel to current flow vectors passing through movable contact 14 thereby generating an attraction force, as shown in FIG. 4. More specifically, the current flow vectors flow substantially in one direction generating an attraction force. In contrast, prior art flux lines diverge from one another forming a reverse loop, such as shown at 80 in FIG. 5, creating a repulsion force that may lead to popping at lower current levels. More specifically, in prior art systems, the current flow vectors flow in opposite directions causing popping or chatter at lower current levels.

At this point, it should be understood that the anti-popping recess shapes magnetic flux field lines and current density fields flowing through contact portion 19 causing a reduction in reverse loop forces that may reduce the repulsion of movable contact 14 away from base member 20. In addition, base member 20 may include a stationary contact member having a geometry, e.g., a position of an end portion relative to base member, that further promotes magnetic flux field lines that enhance forward loop attraction forces. In this manner, the anti-popping recess and the stationary contact member cooperate to establish an attraction force between the stationary contact portion and movable contact. The attraction force opposes repulsion forces that may be created between the stationary contact and the movable contact thereby increasing contact popping level and enhancing performance at higher currents and an overall operational life increase of the circuit breaker. The phrase “popping level” should be understood to describe a condition in which a particular current level causes a popping, chatter and/or vibration of the moveable contact relative to the stationary contact. Increasing the popping level should be understood to mean that the geometry of the stationary contact member increases the level of current that could lead to popping, chatter and/or vibration of the moveable contact relative to the stationary contact. Further, exemplary embodiments increase popping level without a need for additional heavy springs, longer movable contact lever arms, and the like that may be employed to hold contacts together

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A circuit breaker comprising:
a housing;
a movable contact arm arranged in the housing, the movable contact arm including a movable contact; and
a stationary contact assembly arranged in the housing, the stationary contact assembly including a base member including a first side and an opposing second side, an anti-popping recess formed in one of the first and second sides defining a cantilevered arm portion, and a stationary contact member extending from the first side toward the second side.

2. The circuit breaker according to claim 1, wherein the stationary contact member extends along the cantilevered arm portion and includes an end portion that is substantially co-extensive with the second side of the base member.

3. The circuit breaker according to claim 2, wherein the stationary contact member comprises at least one of silver and alloys of silver.

4. The circuit breaker according to claim 1, wherein the stationary contact member includes an end portion that is substantially co-extensive with the wall portion.

5. The circuit breaker according to claim 4, wherein the stationary contact member comprises at least one of silver and alloys of silver.

6. The circuit breaker according to claim 1, wherein the movable contact includes a first end portion, a second end portion and an intermediate portion extending between the first end portion and the second end portion, the first end portion being substantially co-extensive with the wall portion when the movable contact engages the stationary contact assembly.

7. The circuit breaker according to claim 1, wherein the movable contact comprises at least one of silver and alloys of silver.

8. The circuit breaker according to claim 6, wherein the stationary contact member comprises one of silver and alloys of silver.

9. The circuit breaker according to claim 1, wherein the anti-popping recess includes a depth and the cantilevered arm portion and stationary contact member include a thickness, the depth being at a desired ratio relative to the thickness of about 2:7.

10. The circuit breaker according to claim 9, wherein the desired ratio is about 4:6.

11. The circuit breaker according to claim 10, wherein the desired ratio is about 3:5.

12. The circuit breaker according to claim 1, wherein the anti-popping recess includes a wall portion having a depth dimension that is greater than a width of the stationary contact member and the cantilevered arm portion.

13. A circuit breaker comprising:
a housing;
a first contact assembly arranged in the housing, the first contact assembly including a first contact member; and
a second contact assembly arranged in the housing, the second contact assembly including a contact portion having a first side and an opposing, second side, and an anti-popping recess formed in one of the first and second sides defining a cantilevered arm portion, the first contact assembly being attracted toward the second contact assembly upon an application of electrical current through the circuit breaker.

14. The circuit breaker according to claim 13, further comprising a stationary contact member extending across the second contact assembly from the first side toward the second side, the stationary contact member including an end portion that is substantially co-extensive with the second side of the base member.

15. The circuit breaker according to claim 14, wherein the stationary contact member comprises silver.

16. The circuit breaker according to claim 13, further comprising a stationary contact member extending across the second contact assembly from the first side toward the second side, the stationary contact member including an end portion that is substantially co-extensive with the wall portion.

17. The circuit breaker according to claim 16, wherein the stationary contact member comprises at least one of silver and alloys of silver.

18. The circuit breaker according to claim 17, wherein the first contact member comprises one of silver and alloys of silver.

19. The circuit breaker according to claim 13, wherein the anti-popping recess includes a depth and the cantilevered arm portion includes a thickness, the height being at a desired ratio relative to the thickness of about 2:7.

20. The circuit breaker according to claim 13, wherein the anti-popping recess includes a wall portion having a depth dimension that is greater than a width of the stationary contact member and the cantilevered arm portion.
